(19) United States
(12) Patent Application Publication
(10) Pub. No.: US 2026/0188602 A1
(43) Pub. Date: Jul. 2, 2026

(54) FUSE AND MANUFACTURING METHOD THEREOF

(71) Applicant: ADLER Elektrotechnik DongGuan Co., Ltd., Dongguan (CN)

(72) Inventors: Lin Gao, Dongguan (CN); Liguang Li, Dongguan (CN); Xiaobo Li, Dongguan (CN); Meijuan Lei, Dongguan (CN)

(21) Appl. No.: 19/315,456

(22) Filed: Aug. 29, 2025

(30) Foreign Application Priority Data
Dec. 30, 2024 (CN) 202411968972.X

(51) Int. Cl. H01H 85/175; H01H 69/02; H01H 85/143

(52) U.S. Cl. CPC H01H 85/175; H01H 69/02; H01H 85/143

(57) ABSTRACT

A fuse and a manufacturing method thereof, the fuse including: a tube body; a fuse element disposed inside the tube body; two inner caps respectively disposed on two ends of the tube body, where two ends of the fuse element respectively welded to the inner caps respectively disposed on the two ends of the tube body; and two external terminals welded to the inner caps. The present disclosure provides the fuse that allows the external terminals and the inner caps to be welded into one piece, thereby reducing impedance caused by an interference-fit assembly method in the prior art, and reducing power consumption of the fuse while ensuring an electrical protection capability.

### CROSS-REFERENCE TO RELATED APPLICATION

The present disclosure claims the benefit of Chinese patent application No. 202411968972.X, filed on Dec. 30, 2024, which is incorporated herein by reference in its entirety.

### TECHNICAL FIELD

The present disclosure relates to the field of electrical protection, and in particular to a fuse and a manufacturing method thereof.

### BACKGROUND

In applications, power consumption required by fuses are becoming increasingly lower, and electrical protection capabilities of the fuses need to be ensured. At present, the fuses usually use interference fit between an external terminal and an inner cap or a fuse element to achieve electrical connection between the fuse element and the external terminal. However, there is impedance to a certain degree caused by the interference-fit connection method, resulting in higher power consumption.

### SUMMARY

An objective of the present disclosure is to provide a fuse and a manufacturing method thereof, which can reduce power consumption of the fuse while ensuring an electrical protection capability.

To achieve the above objective, the present disclosure provides a fuse, including:
a tube body;
a fuse element disposed inside the tube body;
two inner caps respectively disposed on two ends of the tube body, where two ends of the fuse element are respectively welded to the inner caps respectively disposed on the two ends of the tube body;
two external terminals welded to the inner caps.

In some embodiments of the present disclosure,

Each of the inner caps is provided with a through hole, and the through hole communicates with an interior of the tube body.

In some embodiments of the present disclosure,

Each of the inner caps includes a first connection part and an extension part, the first connection part is tubular, the extension part is disposed at one end of the first connection part, the extension part extends along a radial direction of the first connection part toward a central axis of the first connection part, and the extension part is formed with the through hole, the first connection parts of the inner caps each sleeve over an outer peripheral surface of the tube body at the two ends of the tube body, the extension part is located between the tube body and one of the external terminals, and the fuse element is welded to the extension part.

In some embodiments of the present disclosure,

The external terminals are welded to the extension parts of the inner caps.

In some embodiments of the present disclosure, the fuse further includes:
two outer caps, the outer caps sleeve over the inner caps and at least parts of the external terminals, and the outer caps are configured to limit the external terminals.

In some embodiments of the present disclosure,

Each of the outer caps includes a second connection part and a limiting part, the second connection part sleeves over one of the inner caps and at least a part of one of the external terminals, the limiting part is disposed at one end of the second connection part, and the limiting part fits to the one of the external terminals.

In some embodiments of the present disclosure, the fuse further includes:
An outer sleeve, the outer sleeve sleeves over the inner caps, the tube body, and at least parts of the external terminals.

In some embodiments of the present disclosure,

Each of the external terminals includes a third connection part and a terminal part, an outer diameter of the third connection part is not greater than an outer diameter of each of the inner caps.

In some embodiments of the present disclosure,

The tube body is filled therein with a protective filler.

The present disclosure further provides a manufacturing method of the fuse described above, including following steps:
S1, selecting the tube body, and inserting the fuse element into the tube body;
S2, mounting the inner caps on the two ends of the tube body respectively;
S3, welding the two ends of the fuse element to the inner caps respectively;
S4, welding the external terminals to the inner caps.

In some embodiments of the present disclosure:
S4 specifically includes:
   Welding one of the external terminals, at one end of the tube body, to one of the inner caps corresponding thereto, filling the protective filler in the tube body, and then welding the other of the external terminals, at the other end of the tube body, to the other of the inner caps corresponding thereto.

Compared with the prior art, the present disclosure provides a fuse and a manufacturing method thereof, which have following beneficial effects:
The fuse of the present disclosure includes a tube body, a fuse element, inner caps, and external terminals, the fuse element is disposed inside the tube body, two ends of the fuse element are welded to the inner caps, the external terminals are welded to the inner caps, which allows the external terminals and the inner caps to be welded into one piece, reduces impedance caused by an interference-fit assembly method in the prior art. Thus, power consumption of the fuse is reduced while an electrical protection capability is ensured.

The manufacturing method of the fuse of the present disclosure is used to manufacture the aforementioned fuse, which allows the external terminals and the inner caps to be welded into one piece, reduces the impedance caused by the interference-fit assembly method in the prior art, thereby ensuring the electrical protection capability while reducing the power consumption of the fuse.

### BRIEF DESCRIPTION OF THE DRAWINGS

FIG. 1 is a schematic structural diagram of a fuse with outer caps mounted according to an embodiment of the present disclosure;

FIG. 2 is a sectional view of the fuse of FIG. 1;

FIG. 3 is an enlarged schematic diagram of Part A in FIG. 2.

FIG. 4 is a schematic diagram of a fuse element and inner caps according to the embodiment of the present disclosure;

FIG. 5 is a schematic structural diagram of a tube body according to the embodiment of the present disclosure;

FIG. 6 is a schematic structural diagram of the fuse element according to the embodiment of the present disclosure;

FIG. 7 is a schematic structural diagram of one of the outer caps according to the embodiment of the present disclosure;

FIG. 8 is a schematic structural diagram of one of the inner caps according to the embodiment of the present disclosure;

FIG. 9 is a schematic structural diagram of an external terminal according to the embodiment of the present disclosure;

FIG. 10 is a schematic structural diagram of an external terminal according to another embodiment of the present disclosure;

FIG. 11 is a schematic structural diagram of an external terminal according to a further embodiment of the present disclosure;

FIG. 12 is a schematic structural diagram of the fuse with an outer sleeve mounted according to the embodiment of the present disclosure.

In the figures: 100, fuse; 1, tube body; 2, fuse element; 3, inner cap; 4, external terminal; 5, outer cap; 6, outer sleeve; 31, through hole; 32, first connection part; 321, protrusion; 322, second inclined surface; 33, extension part; 41, third connection part; 411, flange; 412, second groove; 42, terminal part; 51, second connection part; 511, first inclined surface; 52, limiting part; 521, protruding ring; and 522, first groove.

### DETAILED DESCRIPTION

Specific embodiments of the present disclosure are further described in detail below with reference to the accompanying drawings and embodiments. The following embodiments are configured to illustrate the present disclosure, but are not intended to limit the scope of the present disclosure.

In the description of the present disclosure, it should be noted that terms “center”, “longitudinal”, “transverse”, “upper”, “lower”, “front”, “rear”, “left”, “right”, “vertical”, “horizontal”, “top”, “bottom”, “inside”, “outside”, etc., indicates directions or positions based on the directions or positions shown in the accompanying drawings. And the terms are merely configured to facilitate description of the present disclosure and simplify the description, rather than indicating or implying that the device or element referred to must have a specific direction, or be constructed and operated in a specific direction, and therefore the terms cannot be understood as a limitation to the present disclosure. In addition, the terms “first”, “second”, “third”, and the like are used for descriptive purposes only and cannot be understood as indicating or implying relative importance.

In the description of the present disclosure, it should be noted that the terms “mount”, “communication” and “connection” should be understood in a broad sense unless expressly specified and limited otherwise. For example, these terms mean a fixed connection, a detachable connection, or an integral connection; mean a mechanical connection or an electrical connection; and mean a direct connection, an indirect connection via an intermediate medium, or a communication of interiors of two elements. For those of ordinary skill in the art, the specific meanings of the above terms in the present disclosure may be understood according to specific situations.

In addition, in the description of the present disclosure, unless otherwise specified, the term “a plurality of” means two or more.

For those of ordinary skill in the art, the specific meanings of the above term in the present disclosure may be understood according to specific situations.

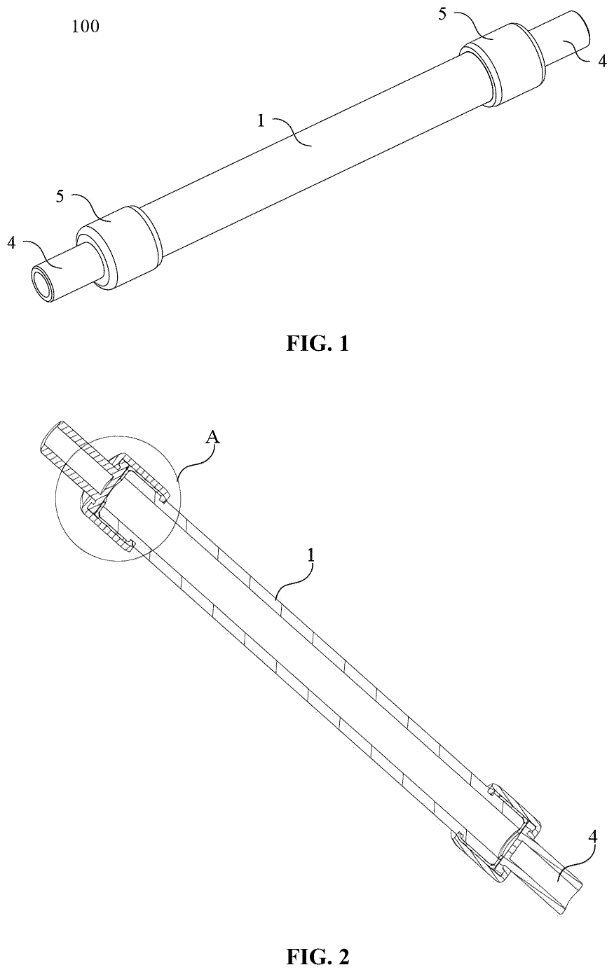

Referring to FIGS. 1-3, a fuse 100 according to an embodiment of the present disclosure, includes: a tube body 1, a fuse element 2, inner caps 3, and external terminals 4.

The tube body 1 is an insulating tube.

The fuse element 2 is disposed inside the tube body 1.

Referring to FIG. 4 and FIG. 6, the inner caps 3 are respectively disposed on two ends of the tube body 1, and two ends of the fuse element 2 are respectively welded to the inner caps 3 respectively disposed on the two ends of the tube body 1.

The external terminal 4 is welded to the inner cap 3. The inner caps 3 are made of conductive material, and the external terminals 4 are made of conductive material.

In this embodiment, the external terminal 4 is directly welded to inner cap 3, allowing the external terminal 4 and the inner cap 3 to be welded into one piece, instead of connecting the external terminal 4 to the inner cap 3 through an interference fit as described in the prior art, thereby reducing impedance caused by the interference-fit assembly method in the prior art, and reducing power consumption of the fuse while ensuring an electrical protection capability.

In this embodiment, the tube body 1 is filled therein with a protective filler.

The protective filler is quartz sand, which is capable of cooling and quenching an electric arc during the use of the fuse 100.

In some embodiments, referring to FIG. 8, the inner cap 3 is provided with a through hole 31, which communicates with an interior of the tube body 1.

When assembling the fuse 100, the through hole 31 facilitates positioning of the fuse element 2 inside the tube body 1, thereby facilitating the welding of the fuse element 2 to the inner cap 3.

In this embodiment, the inner cap 3 includes a first connection part 32 and an extension part 33. The first connection part 32 is tubular, and the extension part 33 is provided at one end of the first connection part 32. The extension part 33 extends along a radial direction of the first connection part 32 toward a central axis of the first connection part 32, and is formed with the through hole 31. The first connection parts 32 of the inner caps 3 each sleeve over an outer peripheral surface of the tube body 1 at the two ends of the tube body 1. The extension part 33 is located between the tube body 1 and the external terminal 4, and the fuse element 2 is welded to the extension part 33.

The first connection part 32 is configured to connect the inner cap 3 to the tube body 1. The extension part 33 is capable of partially covering tube openings at two ends of the tube body 1. The extension part 33 provides a welding position for the fuse element 2. The through hole 31 formed in the extension part 33 facilitates the positioning of the fuse element 2 inside the tube body 1, thereby facilitating the welding of the fuse element 2 to the inner caps 3.

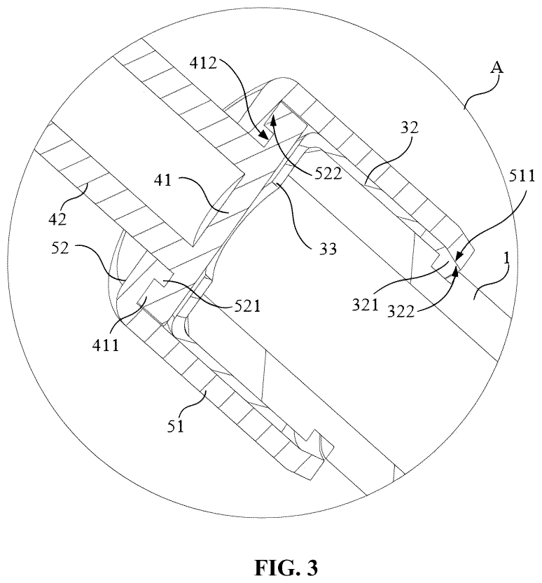

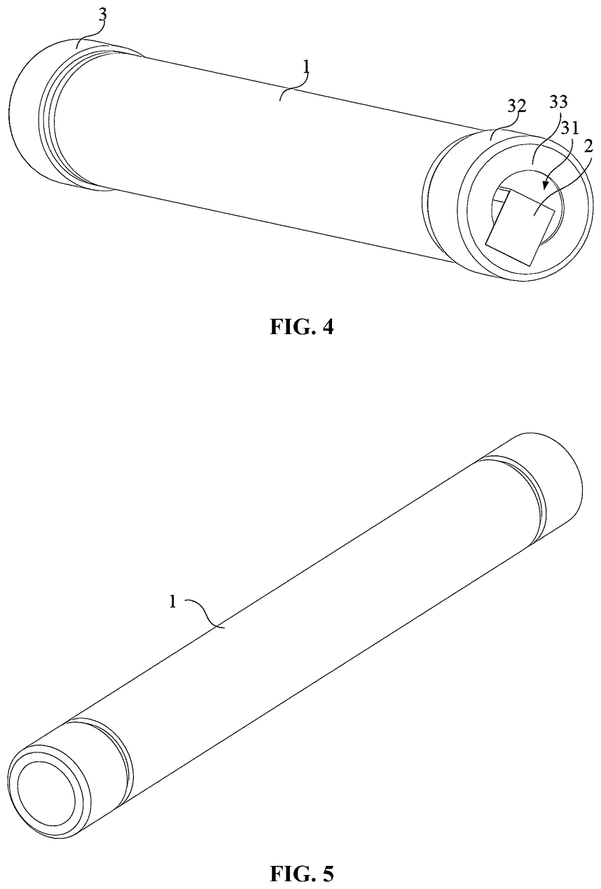

In this embodiment, referring to FIG. 3 and FIG. 5, a tube opening of the first connection part 32 at one end of the first connection part 32 away from the extension part 33 is provided with a protrusion 321. The outer peripheral surface of the tube body 1 is provided with a groove that cooperates with the protrusion 321. The protrusion 321 is inserted into the groove, allowing the inner cap 3 to be fixed to the tube body 1.

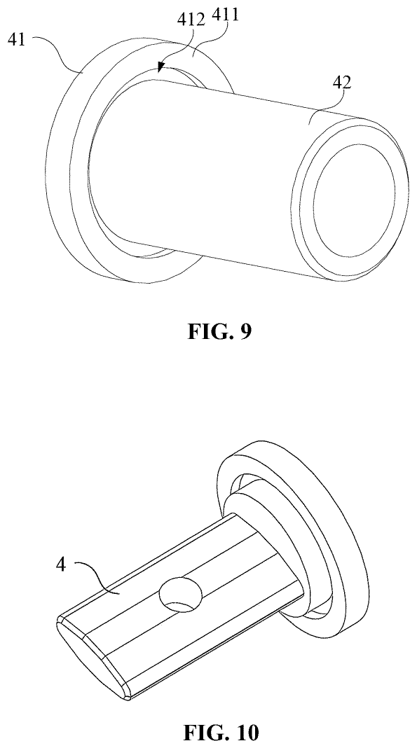

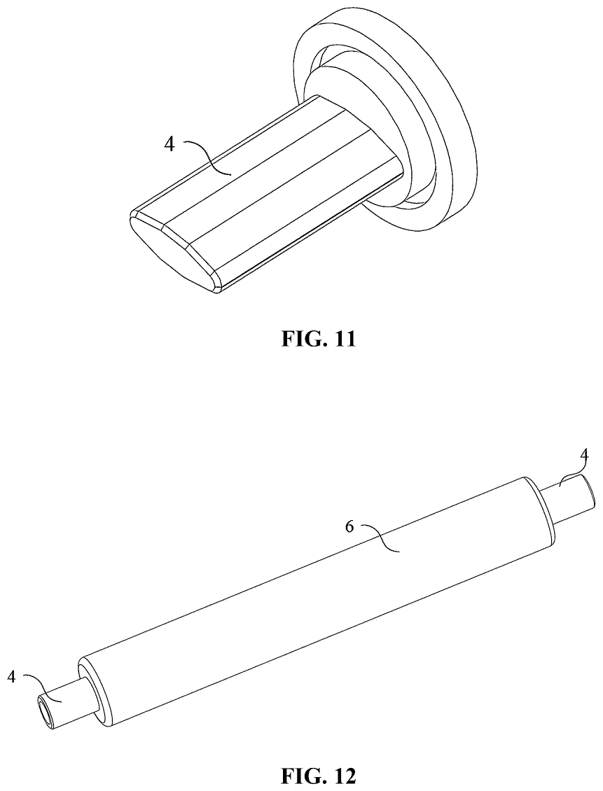

Referring to FIG. 3 and FIG. 9, the external terminal 4 includes a third connection part 41 and a terminal part 42. The external terminal 4 is welded to the extension part 33 through the third connection part 41, forming a direct weld between the external terminal 4 and the inner cap 3, and the external terminal 4 and the inner cap 3 are welded into one piece; an outer diameter of the third connection part 41 is not greater than an outer diameter of the inner cap 3; the terminal part 42 is in a circular tube shape and is configured to be electrically connected to a wire, thereby connecting the fuse 100 to a circuit. In other embodiments, the external terminals 4 in other structural forms may also be used, referring to FIG. 10 and FIG. 11. FIG. 10 shows a bolt-type structure of the external terminal 4, and the terminal part 42 of the external terminal 4 is provided with a through-hole for a bolt to pass through; FIG. 11 shows a blade-type structure of the external terminals 4, and the terminal part 42 of the external terminal 4 is blade-shaped. The structural form of the external terminal is not limited to the above forms, as long as the terminal part 42 can be electrically connected to the wire.

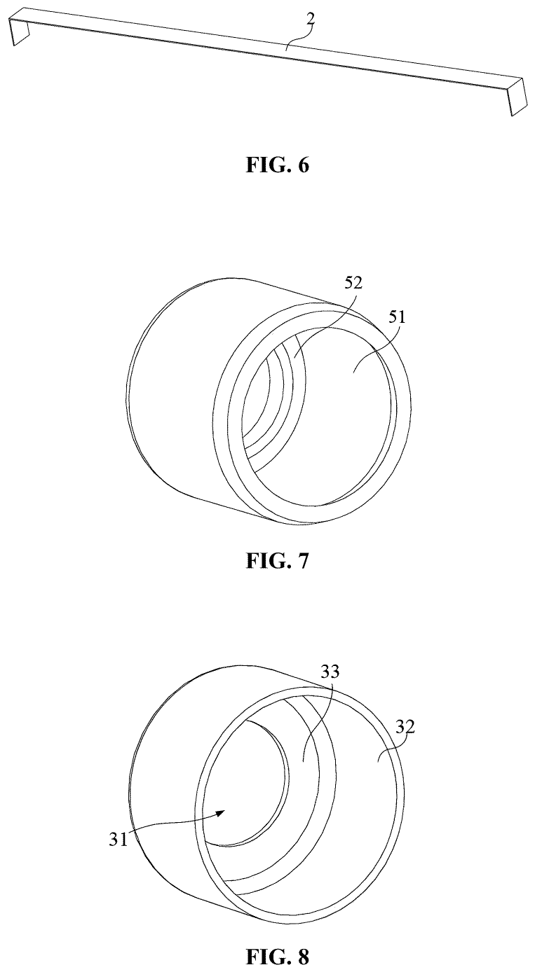

In some embodiments, referring to FIG. 7, the fuse 100 further includes outer caps 5. The outer cap 5 sleeves over the inner cap 3 and at least a part of the external terminal 4. The outer cap 5 is configured to limit the external terminal 4.

The outer cap 5 is configured to reinforce the connection between the external terminal 4 and the inner cap 3. The outer cap 5 is made of conductive material.

The outer cap 5 includes a second connection part 51 and a limiting part 52. The second connection part 51 sleeves over the inner cap 3 and at least the part of the external terminal 4. The limiting part 52 is disposed at one end of the second connection part 51 and fits to the external terminal 4.

Referring to FIG. 3 and FIG. 9, the second connection part 51 is also tubular, and a first inclined surface 511 is provided at a tube opening of the second connection part 51 away from the limiting part 52. A second inclined surface 322 is also provided on the first connection part 32 corresponding to the first inclined surface 511. The two inclined surfaces cooperate to allow the second connection part 51 to be clamped on the first connection part 32 to a certain extent. Additionally, the limiting part 52 is provided with a protruding ring 521, and a first groove 522 is formed between the protruding ring 521 and the second connection part 51. The third connection part 41 of the external terminal 4 is provided with a flange 411, and a second groove 412 is formed between the flange 411 and the terminal part 42 of the external terminal 4. The flange 411 is inserted into the first groove 522 of the outer cap 5, and the protruding ring 521 is inserted into the second groove 412 of the external terminal 4, forming a interlocking structure, so that the outer cap 5 is not only clamped on the first connection part 32, but also clamped on the external terminal 4, thereby reinforcing the connection between the external terminal 4 and the inner cap 3.

In other embodiments, referring to FIG. 12, the fuse 100 further includes an outer sleeve 6, the outer sleeve 6 sleeves over the inner caps 3, the tube body 1, and at least parts of the external terminals 4.

In these embodiments, the outer sleeve 6 replaces the outer caps 5 and is configured to reinforce the connection between the external terminals 4 and the inner caps 3.

The outer sleeve 6 is injection-molded to clamp the external terminals 4, the inner caps 3, and tube body 1, thereby reinforcing the connection between the external terminals 4 and the inner caps 3. The outer sleeve 6 is made of a plastic material, such as a heat-shrinkable material or other engineering plastic material. The heat-shrinkable material may be polyimide, polyolefin, polyethylene terephthalate, or the like.

This embodiment also provides a manufacturing method of the fuse 100 described above, including following steps:
S1, selecting the tube body 1, and inserting the fuse element 2 into the tube body 1,
S2, mounting the inner caps 3 on the two ends of the tube body 1 respectively,
S3, welding the two ends of the fuse element 2 to the inner caps 3 respectively,
S4, welding the external terminals 4 to the inner caps 3,

Specifically, first welding the external terminal 4, at one end of the tube body 1, to the inner cap 3 corresponding thereto, filling the tube body 1 therein with the protective filler, and then welding the external terminal 4, at the other end of the tube body 1, to the inner cap 3 corresponding thereto,
S5. mounting the outer caps 5, or performing injection molding to form the outer sleeve 6.

In a case where the outer sleeve 6 is formed by injection molding, the tube body 1, the inner caps 3, and external terminals 4, which are assembled, are placed into the injection mold, and the outer sleeve 6 is formed by injection molding encapsulating the tube body 1, the inner caps, and at least parts of the external terminals 4.

The manufacturing method of the fuse according to the present disclosure, configured to manufacture the fuse described above, allows the external terminals 4 and the inner caps 3 to be welded into one piece, thereby reducing the impedance caused by the interference-fit assembly method in the prior art, and reducing power consumption of the fuse while ensuring an electrical protection capability.

The above are only preferred embodiments of the present disclosure. It should be noted that, for a person of ordinary skill in the art, several improvements and replacements may be made without departing from the technical principle of the present disclosure, and such improvements and replacements should also be considered within the protection scope of the present disclosure.

1. A fuse, comprising:
a tube body;
a fuse element disposed inside the tube body;
two inner caps, respectively disposed on two ends of the tube body, wherein two ends of the fuse element are respectively welded to the inner caps respectively disposed on the two ends of the tube body; and
two external terminals welded to the inner caps.

2. The fuse according to claim 1, wherein,
each of the inner caps is provided with a through hole, and the through hole communicates with an interior of the tube body.

3. The fuse according to claim 2, wherein,
each of the inner caps comprises a first connection part and an extension part, the first connection part is tubular, the extension part is disposed at one end of the first connection part, the extension part extends along a radial direction of the first connection part toward a central axis of the first connection part, and the extension part is formed with the through hole, the first connection parts of the inner caps each sleeve over an outer peripheral surface of the tube body at the two ends of the tube body, the extension part is located between the tube body and one of the external terminals, and the fuse element is welded to the extension part.

4. The fuse according to claim 3, wherein,
the external terminals are welded to the extension parts of the inner caps.

5. The fuse according to claim 1, further comprising:
two outer caps, wherein the outer caps sleeve over the inner caps and at least parts of the external terminals, and the outer caps are configured to limit the external terminals.

6. The fuse according to claim 5, wherein,
each of the outer caps comprises a second connection part and a limiting part, the second connection part sleeves over one of the inner caps and at least a part of one of the external terminals, the limiting part is disposed at one end of the second connection part, and the limiting part fits to the one of the external terminals.

7. The fuse according to claim 1, further comprising:
an outer sleeve, wherein the outer sleeve sleeves over the inner caps, the tube body, and at least parts of the external terminals.

8. The fuse according to claim 1, wherein,
each of the external terminal comprises a third connection part and a terminal part, and an outer diameter of the third connection part is not greater than an outer diameter of each of the inner caps.

9. The fuse according to claim 1, wherein:
The tube body is filled therein with a protective filler.

10. A manufacturing method of the fuse according to claim 1, comprising following steps:
S1, selecting the tube body, and inserting the fuse element into the tube body;
S2, mounting the inner caps on the two ends of the tube body respectively;
S3, welding the two ends of the fuse element to the inner caps respectively;
S4, welding the external terminals to the inner caps.
